(19) United States
(12) Patent Application Publication
(10) Pub. No.: US 2009/0211407 A1
(43) Pub. Date: Aug. 27, 2009

(54) NUT WRENCH

(76) Inventor: JOHN ARTHUR COLLIER, SURREY (GB)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 12/368,658

(22) Filed: Feb. 10, 2009

(30) Foreign Application Priority Data
Feb. 22, 2008 (GB) 0803268.2

(51) Int. Cl. B25B 13/06; B25B 23/16

(52) U.S. Cl. 81/121.1; 81/177.2

(57) ABSTRACT

The present invention provides a tool for tightening or releasing a nut engaged on a screw-threaded shank. The tool comprises: a socket arrangement comprising a socket for engaging the nut; an extension member adapted to engage the socket arrangement such that a torque applied to the extension piece is transferred to the socket for tightening or releasing the nut; and a location sleeve on the extension member, the location sleeve overlapping the extension member and the socket arrangement, when engaged therewith, so as to hold the extension member to the socket arrangement.

### FIELD OF THE INVENTION

The present invention relates to a tool for tightening or releasing a nut engaged on a screw-threaded shank, particularly, though not exclusively, back nuts on taps for baths, basins, sinks and the like.

### BACKGROUND

There may be many occasions when it is required to tighten or release a nut engaged on a screw-threaded shank, and in many cases access to the nut is restricted. For example, when fixing a tap to a basin, bath, sink or the like, an externally threaded hollow shank at the lower end of the tap is received through an opening in the basin etc. and a back nut is then engaged on the threaded shank. The back nut is tightened (for example, using a box spanner or similar tool) until the back nut tightly engages the underside of the basin, thereby securing the tap in place. Although conventional tools may be generally satisfactory for tightening new back nuts or for undoing recently installed nuts, it can be difficult to undo nuts installed a long time ago, and any other nuts, which are very tight. Multi-part tools are known, where a socket is used to engage the nut and then an extension piece is used to engage the socket so that a torque may be applied to the extension piece to tighten or release the nut. A problem with such tools is that it can be very difficult to locate the socket onto the nut and then locate the extension piece to engage the socket, when this has to be performed in a location with restricted access, like under a kitchen sink.

The present invention has been conceived with the foregoing in mind.

### SUMMARY

According to a first aspect of the present invention there is provided a tool for tightening or releasing a nut engaged on a screwthreaded shank. The tool comprises: a socket arrangement comprising a socket for engaging the nut; an extension member adapted to engage the socket arrangement such that a torque applied to the extension piece is transferred to the socket for tightening or releasing the nut; and a location sleeve on the extension member, the location sleeve overlapping the extension member and the socket arrangement, when engaged therewith, so as to hold the extension member to the socket arrangement

It is an advantage, in use of the tool, that the sleeve can be used to help locate the extension member on the socket arrangement, and subsequently be moved so as to hold the tool components, leaving the operator's hands free for turning the tool.

In embodiments of the invention, the location sleeve is moveable along the extension member from a withdrawn position to a holding position in which the location sleeve overlaps the extension member and the socket arrangement. Alternatively, the location sleeve may be fixed in a holding position on the extension member. The location sleeve may be fixed in the holding position by means of engagement between a reduced diameter portion and a recess in the extension member.

In embodiments of the invention, the extension member comprises a cylindrical form having an outer diameter substantially the same as that of a surface of the socket arrangement, the location sleeve having an annular form with an inner diameter complementary to said outer diameter. The location sleeve may comprise a flared portion to assist location when engaging the extension member with the adapter piece. Preferably, the location sleeve is formed of a resilient plastics material. The plastics material may comprise any suitably resilient or flexible material, for example polyvinyl chloride (PVC).

It is an advantage that, because such plastics materials allow a degree of resilient deformation, the sleeve can be sized to fit tightly around the extension member, while the resilience of the material provides a frictional gripping action to hold the tool components together.

In embodiments of the invention, the socket arrangement comprises an adapter piece having a threaded bore for engaging the shank thread, wherein the socket is supported on the adapter so as to be free to rotate relative thereto. The extension member may be adapted to engage the adapter piece and/or the socket member such that rotation of the extension piece can be used either to rotate just the adapter piece or to rotate the adapter piece and the socket. The extension member may have a first end form for engaging the adapter piece such that rotation of the extension member is effective to rotate the adapter to screw it along said shank without rotating the socket, and a second end form for engaging the adapter piece together with the socket such that rotation of the extension member is effective to rotate both the adapter piece and the socket. The adapter piece may be adapted to support any one of a plurality of socket members sized to engage different nut sizes.

The tool may further comprise a driver piece adapted to engage an end of the extension member remote from the engagement with the adapter piece. The driver piece may comprise a hexagonal form for receiving a tool such as a spanner to apply torque to the tool. The tool may further comprise a second location sleeve on the extension member overlapping the extension member and the driver piece, when engaged therewith, so as to hold the extension member to the driver piece. The extension member may have a cylindrical or tubular form with an outer diameter substantially the same as that of a surface of the driver piece, the second location sleeve having an annular form with an inner diameter complementary to said outer diameter. The second location sleeve may comprise a flared portion to assist location when engaging the extension member with the driver piece. The second location sleeve is preferably formed of a resilient flexible plastics material, preferably PVC or suitably flexible material.

According to a second aspect of the present invention there is provided a tool for tightening or releasing a nut engaged on a screw-threaded shank. The tool comprises: a socket for engaging the nut; an adapter piece having a threaded bore for engaging the shank thread, wherein the socket is supported on the adapter piece so as to be free to rotate relative thereto; and an extension member adapted to allow engagement in one configuration with only the adapter piece and in another configuration with the adapter piece and the socket member, such that rotation of the extension piece can be used to rotate either just the adapter piece or the adapter piece and the socket for tightening or releasing the nut.

### BRIEF DESCRIPTION OF THE DRAWINGS

FIG. 1 shows an assembly of a nut wrench tool.

FIG. 2 shows a socket arrangement forming part of the tool of FIG. 1.

FIG. 3 shows an extension member forming part of the tool of FIG. 1.

FIG. 4 shows a driver piece forming part of the tool of FIG. 1.

FIG. 5 shows location sleeves for use on the tool of FIG. 1.

### DETAILED DESCRIPTION OF EMBODIMENTS

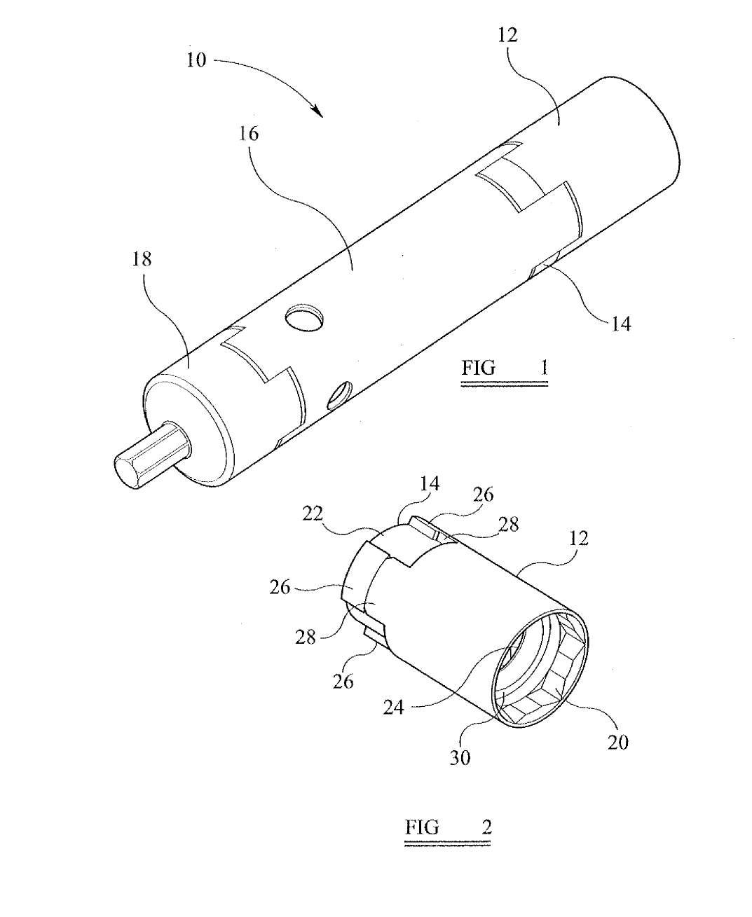

Referring to FIG. 1, a nut wrench 10 is made up of an assembly of parts including a socket arrangement formed of a socket 12 supported on an adapter 14, a tubular extension member 16 and a driver piece 18. The nut wrench is particularly useful in tightening or releasing back nuts on taps of basins, baths, sinks or the like, as will be described in more detail below.

FIG. 2 shows the socket arrangement. The socket 12 includes hexagonal socket faces 20 for engaging the flats of a hexagonal headed nut (not shown). It will be appreciated that different shapes of socket could be provided to suit different shaped nut heads. The socket 12 has an inner bore (not shown) and a supporting cylindrical surface 22 of the adapter 14 extends a predetermined length inside the inner bore. Accordingly, the socket 12 is supported by the adapter 14, but is free to rotate around it. The adapter 14 has a plurality of lugs 26 (three are shown in this embodiment) at the end protruding externally of the socket 14. The lugs 26 have outer surfaces that lie on a cylinder having substantially the same diameter as the socket 12. The socket 12 has a plurality (three in the illustrated embodiment) of legs 28 of corresponding size to the lugs 26. In the position of the socket 12 shown in FIG. 2, the legs 28 are aligned with the lugs 26 to provide three recesses in the outer cylindrical surface. However, it will be appreciated that in a different angular position of the socket 12 on the adapter 14, the legs 28 will not be aligned with the lugs 26.

In some embodiments, the adapter piece 14 may be free to slide axially into or out of the socket 12. In such embodiments, the socket may be one of a set of sockets of different size or shape that are interchangeable to suit a variety of nut sizes or types.

In another embodiment, the adapter piece 14 and the socket 12 are joined to form a single component socket arrangement. The adapter piece 14 has an end 30 that is swaged after it has been inserted into the socket during an initial assembly process. The swaged end 30 is flared outwards so as to radially overlap an annular surface in the socket 12. This means that the socket 12 is still free to rotate relative to the adapter 14, but the two components cannot be separated axially.

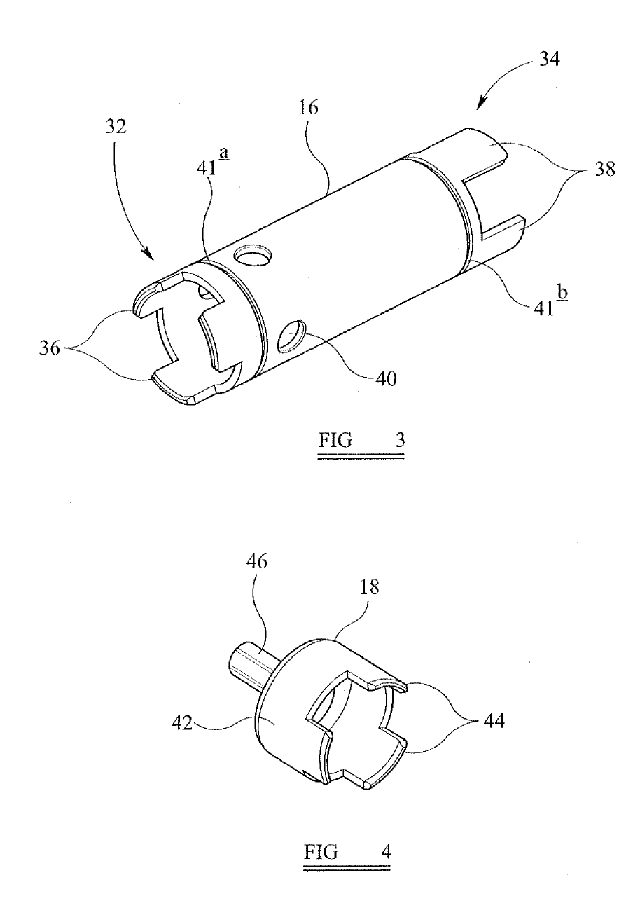

FIG. 3 shows the extension member 16, which is formed as a tubular component. The inner diameter of the tube wall corresponds to the diameter of the supporting cylindrical surface 22 of the adapter piece 14, while the outer diameter of the tube wall corresponds to that of the outer surface of the lugs 26 and the outer diameter of the socket 12.

The extension member 16 has a first end 32 and a second end 34. The first end 32 includes a plurality (three in the illustrated embodiment) of relatively short axially extending portions of tube wall, or first end legs 36, defining a plurality of cut-outs between the legs. The first end legs 36 and cut-outs are of a size that corresponds with the lugs of the adapter piece 14, so that when the first end 32 of the extension member 16 is offered up to and axially aligned with the socket arrangement, the first end legs 36 engage in the recesses between the lugs 26, while the lugs 26 engage in the cut-outs. However, the legs 36 are not long enough to engage in the recesses between the legs 28 of the socket 12.

The second end 34 of the extension member 16 includes a similarly arranged set of relatively long axially extending portions or second end legs 38. The second end legs 38 are longer than the first end legs so that, when the second end 34 of the extension member 16 is coupled to the socket arrangement, the second end legs 38 can engage both the lugs 26 of the adapter piece 14 and the legs 28 of the socket 12. It will be appreciated that because it is the ends 32, 34 of the extension member 16 that engage the socket arrangement, the entire length of the extension member does not need not be of a uniform diameter or wall thickness.

The extension member 16 also includes a diametrically opposed pairs of holes 40 for receiving a tommy bar, which can be used for exerting a torque to the extension member to turn the socket arrangement. In addition, the extension member 16 of FIG. 3 shows a pair of circumferential recesses grooves 41a, 41b. the function of these will be described further below.

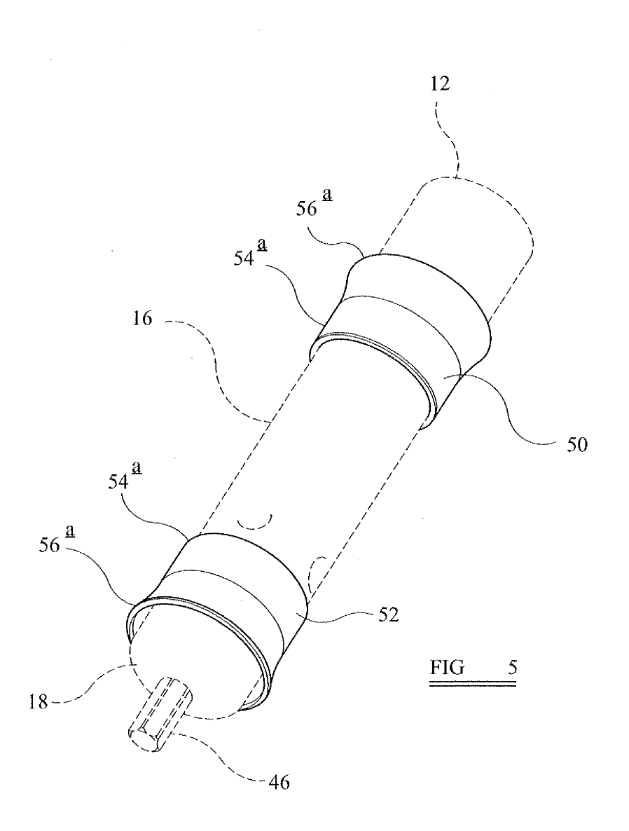

Referring to FIG. 4, the driver piece 18 has the form of a relatively short tubular section with an outer cylindrical surface 42 of corresponding size to the tube of the extension member 16 in FIGS. 1 and 3. One end of the driver piece has a set of driver legs 44 arranged in the same manner as the first end legs 26 of the extension member 16. These driver legs 44 may be used to engage the first or second end legs of the extension member 16. Extending axially from the other end of the driver piece 18 is a hexagonal bar 46 that can be used with a spanner or similar tool to provide a torque to rotate the driver piece 18.

Referring again to FIG. 1, in use to release a back nut engaged on a threaded shank (not shown), the socket arrangement of FIG. 2 is first placed over the end of the shank such that the screw threads 24 engage the threads on the shank, and so that the socket is oriented towards the back nut. Once engaged on the shank, the first end 32 of the extension member 16 is offered up so as to engage the socket arrangement with the shorter first end legs 36 sliding into the recesses between the lugs 26 of the adapter piece 14. The assembly can then be used to screw the adapter piece onto the shank by rotating the extension member 16 by hand, or with the aid of a tommy bar inserted in the holes 40, if required.

Once the adapter piece has been screwed far enough, the socket 12 reaches the back nut and the hexagonal socket faces 20 can engage onto the hexagonal flats of the back nut. The extension member 16 can be disengaged from the adapter piece and removed. The socket arrangement—adapter piece 14 and socket 12 will remain in position because the adapter piece is threaded onto the shank. Now the socket 12 and the adapter piece 14 are aligned such that the lugs 26 are in line with the legs 28. The extension member 16 is turned around and the second end 34 is offered up so as to engage the socket arrangement with the longer, second end legs 36 sliding into the recesses between the lugs 26 of the adapter piece 14 and the legs 28 of the socket 12.

The driver piece 18 is then inserted onto the end of the extension member 16 such that the driver legs 44 engage in the recesses between the first end legs 36. The entire assembly can then be used to release the back nut by applying torque to the driver piece 18, with the aid of a spanner on the hexagonal bar 46.

It will be appreciated that the same procedure can be used to tighten a back nut, just by applying the torque in the opposite, tightening direction.

Especially in awkward and restricted spaces, it may be difficult for the operator to locate, and maintain engagement between, the extension member 16 and the socket arrangement, as well as the driver piece 18 and the extension member 16. FIG. 5 shows how this problem is overcome. In FIG. 5, the tool assembly 10 of FIG. 1 is shown in broken lines, with the same reference numerals being used for the tool components. Surrounding the tubular form of the tool 10 are a first sleeve 50 and a second sleeve 52. Each of these sleeves has a straight tubular portion 54a, 54b and a flared portion 56a, 56b. As shown in FIG. 5, the first sleeve 50 is mounted towards an upper end of the extension member 16, such that the flared portion 56a extends towards the socket 12, while the second sleeve 52 is mounted towards a lower end of the extension member 16, such that the flared portion 56b extends towards the driver piece 18.

Each of the first and second sleeves 50, 52 is formed of a plastics material that permits a degree of resilient deformation, such as PVC. The tubular portions 54a, 54b of the sleeves 50, 52, have an internal diameter that forms an interference fit with the outer diameter of the extension member 16 (and the corresponding diameters of the other components of the tool 10), such that the sleeves 50, 52 have to be urged onto the tool 10. Once in position around the extension member 16, the sleeves 50, 52 can be moved axially along the extension member 16 by the application of sufficient force to overcome the friction caused by the interference fit and the resilience of the plastics material.

In use, when the extension member 18 is first offered up to the socket arrangement, the first sleeve 50 is positioned at the first end 32 of the extension member 16, such that the flared portion 56a extends over the first end legs 36. The flared portion 56a of the first sleeve 50 can be used to provide a guide or lead-in to help locate the first end legs 36 so that they engage with the lugs 26 on the adapter piece 14. Once engaged, the first sleeve 50 is then pushed upwards until the tubular portion 54a overlaps the lugs 26. In that position, the frictional forces of the first sleeve 50 grip both the extension member 16 and the adapter piece 14, holding the two parts together and leaving the operator's hands free to rotate the tool.

A similar approach is used when the extension member 16 is turned around to apply torque to the socket 12. Here the second sleeve 52 is used to help locate the second end 34 of the extension member 16 onto the socket and to hold the parts together. In this case the first sleeve 50 may also be used to help locate and to hold the driver piece 18 onto the other end of the extension member 16.

Referring to FIGS. 3 and 5, in an alternative arrangement, the sleeves 50, 52, may be in a fixed position on the extension member 16. The grooves 41a, 41b shown in FIG. 3 form a locating position for the sleeves 50, 52. Each sleeve 50, 52 is first formed with a closed end (at the un-flared end), for example in a dip moulding operation. The closed ends are then punched out to make both ends open. The punched out end hole has a diameter that is smaller than the inside diameter of the rest of the parallel section of the sleeve moulding. The punched out ends then each engage in a respective one of the circumferential grooves 41a, 41b formed in the outside of the extension member 16.

1. A tool for tightening or releasing a nut engaged on a screw-threaded shank, the tool comprising:
a socket arrangement comprising a socket for engaging the nut;
an extension member adapted to engage the socket arrangement such that a torque applied to the extension member is transferred to the socket for tightening or releasing the nut; and
a location sleeve on the extension member, the location sleeve overlapping the extension member and the socket arrangement, when engaged therewith, so as to hold the extension member to the socket arrangement.

2. The tool of claim 1, wherein the location sleeve is moveable along the extension member from a withdrawn position to a holding position in which the location sleeve overlaps the extension member and the socket arrangement.

3. The tool of claim 1, wherein the location sleeve is fixed in a holding position on the extension member.

4. The tool of claim 3, wherein the location sleeve is fixed in the holding position by means of engagement between a reduced diameter portion of the location sleeve and a recess in the extension member.

5. The tool of claim 1, wherein the extension member comprises a cylindrical form having an outer diameter substantially the same as that of a surface of the socket arrangement, the location sleeve having an annular form with an inner diameter complementary to said outer diameter.

6. The tool of claim 1 wherein the location sleeve comprises a flared portion to assist location when engaging the extension member with the adapter piece.

7. The tool of claim 1, wherein the location sleeve has a size that provides a tight fit around the extension member.

8. The tool of claim 1, wherein the location sleeve is formed of a resilient plastics material, such as poly vinyl chloride.

9. The tool of claim 1, wherein the socket arrangement comprises an adapter piece having a threaded bore for engaging the shank thread, wherein the socket is supported on the adapter so as to be free to rotate relative thereto.

10. The tool of claim 9 wherein the extension member is adapted to engage the adapter piece and/or the socket member such that rotation of the extension piece can be used either to rotate just the adapter piece or to rotate the adapter piece and the socket.

11. The tool of claim 10 wherein the extension member has a first end form for engaging the adapter piece such that rotation of the extension member is effective to rotate the adapter to screw it along said shank without rotating the socket, and a second end form for engaging the adapter piece together with the socket such that rotation of the extension member is effective to rotate both the adapter piece and the socket.

12. The tool of any of claim 9, wherein the adapter piece is adapted to support any one of a plurality of socket members sized to engage different nut sizes.

13. The tool of claim 1 further comprising a driver piece adapted to engage an end of the extension member remote from the engagement with the socket arrangement.

14. The tool of claim 13, wherein the driver piece comprises a hexagonal form for receiving a tool such as a spanner to apply torque to the tool.

15. The tool of claim 13 further comprising a second location sleeve on the extension member, the second location sleeve overlapping the extension member and the driver piece, when engaged therewith, so as to hold the extension member to the driver piece.

16. The tool of claim 13, wherein the extension member comprises a cylindrical form having an outer diameter substantially the same as that of a surface of the driver piece, the second location sleeve having an annular form with an inner diameter complementary to said outer diameter.

17. The tool of claim 15, wherein the second location sleeve comprises a flared portion to assist location when engaging the extension member with the driver piece.

18. The tool of claim 15, wherein the second location sleeve is formed of a resilient plastics material, such as polyvinyl chloride.

19. A tool for tightening or releasing a nut engaged on a screw-threaded shank, the tool comprising:
a socket for engaging the nut;
an adapter piece having a threaded bore for engaging the shank thread, wherein the socket is supported on the adapter piece so as to be free to rotate relative thereto; and
an extension member adapted to allow engagement in one configuration with only the adapter piece and in another configuration with the adapter piece and the socket member such that rotation of the extension piece can be used to rotate either just the adapter piece or the adapter piece and the socket for tightening or releasing the nut.

20. The tool of claim 19, wherein the extension member has a first end form for engaging the adapter piece such that rotation of the extension member is effective to rotate the adapter to screw it along said shank without rotating the socket, and a second end form for engaging the adapter piece together with the socket such that rotation of the extension member is effective to rotate both the adapter piece and the socket.

21. The tool of claim 19, wherein the adapter piece is adapted to support any one of a plurality of socket members sized to engage different nut sizes.

22. The tool of claim 19, further comprising a driver piece adapted to engage an end of the extension member remote from the engagement with the socket arrangement.

23. The tool of claim 19, further comprising one or more location sleeves on the extension member, the location sleeves overlapping the extension member and the adapter piece and/or the driver piece, when engaged therewith, so as to hold the extension member to the adapter and/or driver piece.

24. The tool of claim 23, wherein the location sleeve comprises a flared portion to assist location when engaging the extension member with the adapter piece/driver piece.

25. The tool of claim 23, wherein the location sleeve is formed of a resilient plastics material, such as polyvinyl chloride.
